(19) United States
(12) Patent Application Publication
(10) Pub. No.: US 2006/0053913 A1
(43) Pub. Date: Mar. 16, 2006

(54) Mechanical actuator for electric starter

(76) Inventor: William K. Sinn, Oswego, IL (US)

Correspondence Address: James D. Palmatier;Patent Attorney, Palmatier Law Office, PO Box 231, Itasca, IL, 60143-0231, US

(21) Appl. No.: 10/917,205

(22) Filed: Aug. 10, 2004

(51) Int. Cl. F02N 15/06

(52) U.S. Cl. 74/6

(57) ABSTRACT

An apparatus and method of starting an internal combustion engine having an electric starter without engaging the starter relay or the starter solenoid. The mechanical actuator has a base that mounts on the end of the solenoid case to engage the solenoid armature with a drive rod translated axially, aligned and in parallel with the solenoid armature to engage the armature and push it into position to engage the engine flywheel and energize the starter motor. The rotational drive unit translates rotary motion of the handle on the drive rod to linear motion along the axis of the drive rod allowing the user to start the engine if the starter relay or solenoid have failed.

### CROSS-REFERENCE TO RELATED APPLICATIONS

N/A

### STATEMENT REGARDING FEDERALLY SPONSORED RESEARCH OR DEVELOPMENT

N/A

### REFERENCE TO A SEQUENCE LISTING, A TABLE, OR A COMPUTER PROGRAM LISTING

N/A

### COMPACT DISC APPENDIX

N/A

### FIELD OF THE INVENTION

This invention relates to parts for internal combustion engines more specifically to components for engine starter systems.

### BACKGROUND OF THE INVENTION

Internal combustion engines are use for powering many forms of personal transportation.

Cars, trucks and motorcycles use engines to provide mobile power for transportation in all parts of the world.

Internal combustion engines usually have an output shaft that is connected to a flywheel on the outside of the engine.

Starting internal combustion engines starts with engaging the flywheel and turning it to cause the engine to start. Usually the starting device is connected to the gear assembly to give better leverage to output shaft causing the engine to turn over.

Early engines used a manual start device in the form of a crank or kick start connected to the flywheel with a one-way connection to allow the user to engage the crank with their arm or foot to turn the crank thus turning the flywheel and causing the combustion cycle to begin. This was dangerous as it usually put the user in a mechanical connection to the engine. A back fire or lurch of the engine caused by misfiring the fuel at the improper position of the piston could cause injury to the person starting the engine.

An electric starter assembly was designed to use electric motors to engage the flywheel and turn the crankshaft to initiate the combustion cycle. The electric starter assembly uses a pinion gear on the electric starter drive shaft to engage the flywheel. A requirement of the electric starter assembly was while the engine was running, the starter motor must be disengaged from the engine. To achieve this the pinion gear of the starter motor must be axially displaced from a rest position to an engagement position to engage the flywheel. Upon starting the engine, the pinion gear must return to the non-engaged position. The most common system used for axial translation of the starter is called a BENDIX type system wherein the pinion gear slidably moves along the starter drive shaft to engage the flywheel while starting. The pinion gear is biased in the non-engagement position by a spring assembly to return to the non-engagement position. A solenoid or gear motor is used to engage the pinion gear and move it along the shaft of the starter motor to engage the flywheel. In U.S. Pat. No. 4,319,139 by Mazzorana, herein incorporated in its entirety, a small motor is used to move the pinion gear into engagement with the flywheel. Alternatively, a solenoid assembly is disclosed in U.S. Pat. No. 5,475,270 to McRoy, herein incorporated in its entirety, to engage the pinion gear and sequentially engage the starter motor.

The mechanical linkage between the solenoid and the pinion gear gives a mechanical advantage to overcome the spring bias and move the pinion gear to the engagement position. When the solenoid is in the energized position and the pinion gear is in the engagement position an electrical contact is made between the battery and the starter motor to cause the starter motor to spin thus turning the flywheel and starting the engine.

A one way clutch is used to prevent the flywheel from overturning the starter motor and back driving the starter motor causing damage.

The solenoid is energized by a starter relay making electrical connection between the battery and the solenoid. A start button or a start position on the key switch engages the starter relay.

The disadvantage of these systems is that the solenoid is subjected to shock and vibration during the operating period of the engine. Furthermore the starter relay is also subjected to such shock and vibration. These components may fail often while the vehicle is being used on rough terrain. The problem is especially prevalent on motorcycles which may be used on rougher terrain or have less shock absorbing capabilities.

Therefore there is a need to provide an alternate device and method of engaging the starter to start the engine in case of a failure of the starter relay or solenoid.

### SUMMARY OF THE INVENTION

It is therefore and object of the present invention to provide an improved method and apparatus to utilize the electric starter for starting an internal combustion engine.

An object of the invention is to provide an apparatus that can be produced at a relatively low cost.

Another object of the invention is to provide an apparatus that can be retrofitted to existing starter systems.

Another object of the present invention is to provide an apparatus that can be used with an existing starter system.

Another object of the invention is to provide an apparatus that can be used in combination with existing starter systems.

another object of the present invention is and apparatus that is adjustable to adapt to different existing starter assemblies.

### BREIF DESCRIPTION OF THE DRAWINGS

FIG. 1 is a side outline view showing the placement of the present invention on a motorcycle

FIG. 2 is a partly sectional view of a starter assembly using a solenoid for engaging the pinion gear to the flywheel.

FIG. 3. is a plan view of a starter assembly showing the present invention mounted thereon.

FIG. 4. is a plan view of a starter assembly showing an alternative embodiment of the present invention in the engaged position.

FIG. 5 is a plan view of the present invention FIG. 6 is an exploded view of the present invention.

### SPECIFIC DESCRIPTION

The present invention provides an alternate method and apparatus for using the electric starter motor to start an internal combustion engine. The apparatus is mounted on a starter assembly for mechanically engaging an electrical solenoid without energizing the solenoid coil.

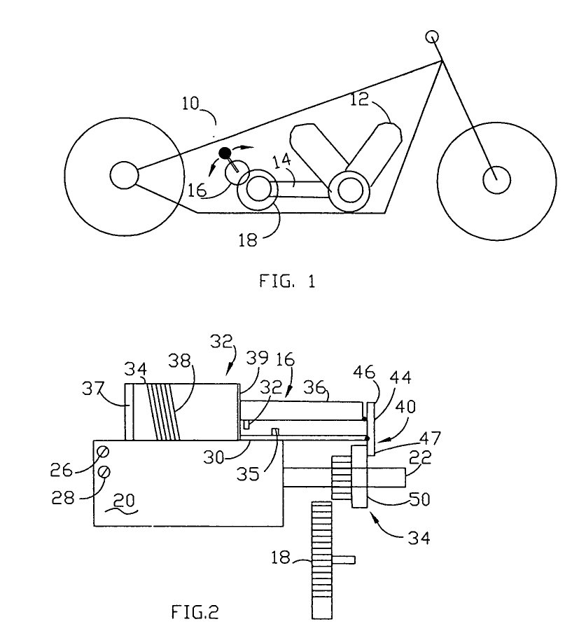

A motorcycle 10 having an engine 12 and gearbox 14 is shown in FIG. 1. The starter assembly 16 is mounted on the gearbox to engage a flywheel 18 that is connected to the engine 12.

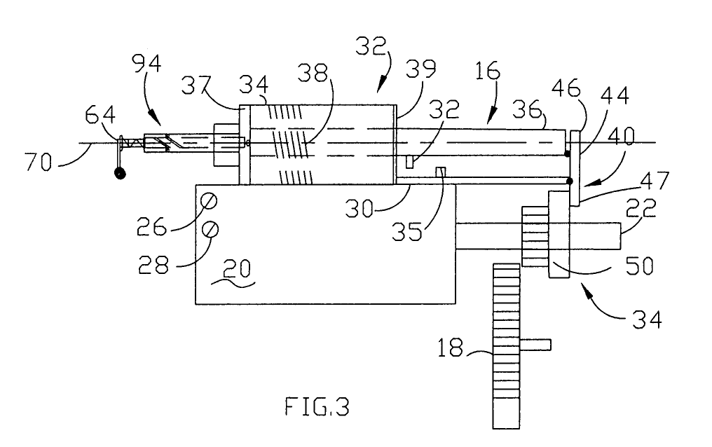

Referring to FIG. 2, the starter assembly 16 has a starter motor 20 having a drive shaft 22 and a pinion gear 24 slidably mounted on the drive shaft 22. A first electrical connection 26 and a second electrical connection 28 are used to connect to a battery (not shown).

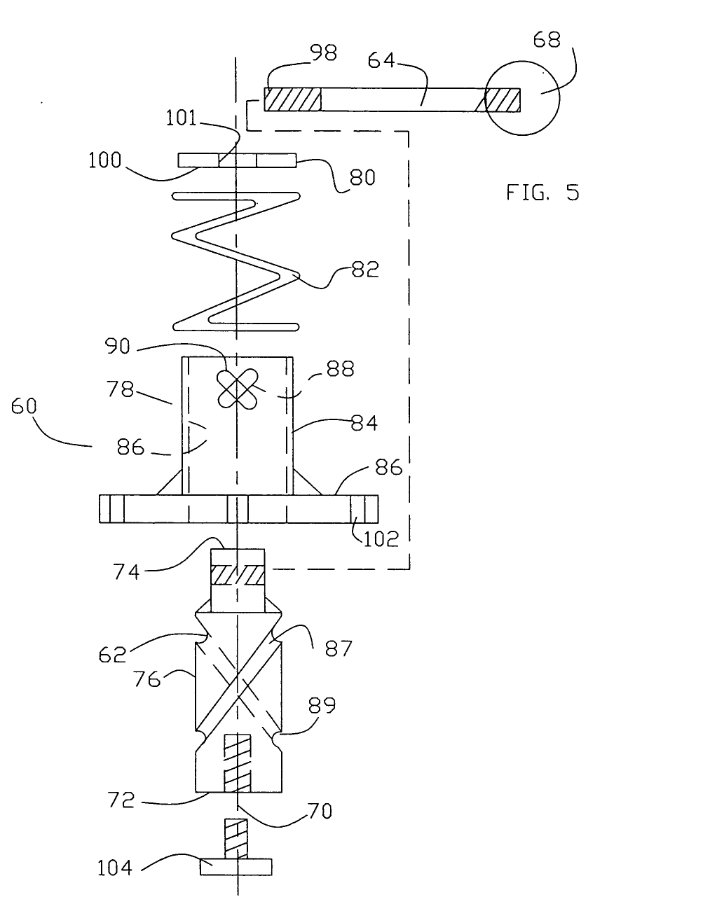

The second electrical connection 28 is connected to the battery and the first electrical connection 26 is connected to the switch 30 on the solenoid 32. The pinion gear 24 is slidable from a non-engaged position 34 to an engaged position 33 (FIG. 4) along the drive shaft 22.

The solenoid 32 on the assembly 16 has a case 34, an armature 36, a coil 38 connected between the case 34 and the armature 36. The switch 30 has a first electrical contact 32 and a second electrical contact 35 The case 34 has an end cap 37 and an armature cap 39.

The first electrical contact 32 is connected to the armature 36 and connected to the first electrical connection 26 on the starter motor and to the battery (not shown). The second electrical contact 35 on the case 34 is connected to an alternate pole of the battery (not shown). The switch makes the connection between the electrical contacts 32, 35 when the coil 38 creates a magnetic field causing the armature 36 to move axially from a rest position 40 to an actuated position 42 (FIG. 4). This axial movement of the armature 36 causes the first electrical contact 32 to electrically engage the second electrical contact 35 creating an energizing circuit between the battery (not shown) and the starter motor 20

A pivot lever 44 is pivotably mounted on the assembly 16. The pivot lever 44 has a solenoid end 46 on the armature 36 and a gear end 47 on the pinion gear 24. A pivot point 48 on the assembly 16 connects the pivot lever 44 to translate the motion of the armature 36 to the pinion gear 24. The pinion gear 24 is supported by a one-way bearing 50 that slidably engages the drive shaft 22. The lever 44 is configured to position the pinion gear 24 in the non-engaging position 34 when the armature 36 is in the rest position 40 and pivoting about the pivot point 48 when the armature 36 is moved to slide the pinion gear 24 into the engaged position 33 (FIG. 4).

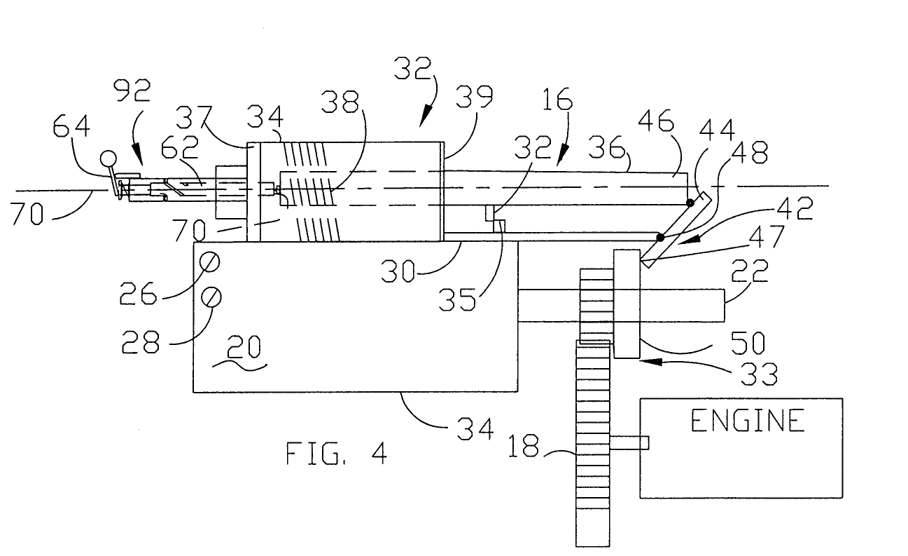

A mechanical actuator 60 is mounted on the end cap 37 in FIG. 3. The mechanical actuator 60 has a drive rod 62, a handle 64 with a knob 68. The drive rod 62 further comprises an axis 70, a armature end 72 bearing against the armature 36 and a handle end 74 connected to the handle 64 and an outer surface 76. A spiral rod drive 78 in the actuator 60 moves the drive rod 62 axially to engage the armature 36 and push it into the actuated position 42 (FIG. 4).

The mechanical actuator 60 further comprises a spring retainer 80 mounted on the drive rod between the handle and a spring 82. The spring 82 bears against the rod tube 84 mounted on the base 86. The base 86 is the end cap 37 modified to accept the mechanical actuator 60. The rod tube 84 has a cylindrical hollow inner surface 86 for slidably receiving the drive rod 62.

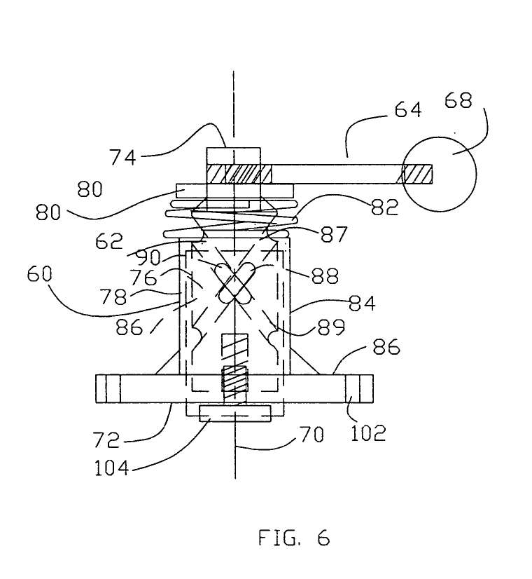

The spiral rod drive 78 comprises a first rod guide 88 formed in the rod tube 84 extending from the inner surface 86. A mating first helical slot 87 is formed in the outer surface 76 of the drive rod. A second rod guide 90 (FIG. 5) is formed to engage and slidably interface with a second helical slot 89 in the drive rod 62. The plurality of rod guides 88, 90 align with the plurality of helical slots 87, 89 to translate the rotational turning of the drive rod 62 by handle 64 into an axial motion along the axis of the drive rod 62.

The handle 64 is configured to move the drive rod 62 axially between a start position 92 (FIG. 4) and a non-start position 94. The start position 92 has the drive rod 62 engaged with the armature 36 to bear against and mechanically move the armature 36 to the actuated position 42 (FIG. 4).

Referring to FIG. 4 an alternate sliding arrangement is shown having a handle 64 that is pushed or pulled in a direction parallel to the axis 70 of the drive rod 62. The handle 64 is shown in the start position 92 bearing against the armature 36 to move the armature into the actuated position 42 causing the switch 30 to make contact between the first electrical contact 32 and the second electrical contact 35 thereby energizing the starter motor. The pivot lever 44 pivots to slide the pinion gear 24 into the engaged position 33.

Referring to FIG. 5 and exploded view of the mechanical actuator 60 illustrates the handle 64 having a knob 68 and a threaded end 98 for engaging the drive rod 62. The spring retainer 80 is shaped like a washer having a flat surface 100 for engaging the spring 82 and an aperture 101 for receiving the handle end 74 of the drive rod. The spring 82 bears against the spring retainer 80 which is held on the drive rod 62 by the handle 64. The spring 82 also bears against the base 86 at the rod tube 84 to urge the drive rod 62 away from the armature 36.

The base 86 is shown having a cylindrical inner surface 86 and a plurality of rod guides 88, 90 are formed extending from the inner surface to engage the helical slots 87, 89 on the outer surface 76 of the drive rod 62. The base 86 has a mounting surface 102 to mount to the solenoid case 34. The mounting hole pattern on the base 86 is the same as the mounting hole pattern for the end cap that was removed. It should be understood, the end cap may be modified to accommodate the mechanical actuator 60 or the end cap 37 may be removed and disposed of and replaced with a mechanical actuator 60 having a base that mounts on the solenoid to replace the end cap 37 and add the functionality of the present invention.

A depth adjuster 104 is threadably mounted on the armature end 72 of the drive rod 62. The depth adjuster is adjusted to accommodate different clearance between the base and the end of the armature 36 in different manufacturers' solenoids.

In operation, the end cap 37 is removed from the solenoid case 34 and replaced by the mechanical actuator 60 of the present invention. The clearance is checked when the solenoid is at the rest position 40 and the spring 82 has pushed to drive rod 62 in its outward position. The drive rod is held in the base by one of the guides 88, 90 bearing against the closed distal end 106 of the helical slot 87, 89.

The mechanical actuator is assembled by threadably attaching the adjuster 104 to the armature end 72 of the drive rod. The drive rod 62 is inserted into the base from the mounting surface 102 side while making sure to engage the plurality of guides 88, 90 into the plurality of helical slots 87, 89. The spring 82 is placed over the handle end of the drive rod 62 and the spring retainer placed on top of the spring. The handle 64 is attached to the drive rod 62 to hold the spring retainer and spring in place.

The mounting surface 102 is placed on the solenoid case 34 and clearance is checked between the armature end of the drive rod 62 and the armature 36. The depth adjuster 104 is used to extend from the armature end of the drive rod to minimize the gap between the drive rod 62 with depth adjuster 104 extended and the armature 36. This adjustment minimizes the excess travel required by the drive rod to move the armature into the actuated position 42.

When the proper adjustment has been made to the depth adjuster 104 a commercially available thread lock 108 is applied to hold the depth adjuster in place. The base 86 is attached to the solenoid case 34 using the same or similar but longer threaded fasteners used to hold the end cap 37.

The engine may be started by turning the ignition on and actuating the handle 64 to cause the drive rod 62 to engage the armature 36 driving the pinion gear into the engaged position 36 and closing the contacts 32, 35 to excite the starter motor 20 turning the flywheel and starting the engine.

The rod guides may be pressed into the wall of the rod tube or welded on to the inner surface of the rod tube or otherwise formed to extend into the interior cylindrical area of the rod tube 84 to engage the helical slots in the drive rod.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

I claim:

1. An apparatus for mounting on a starter assembly comprising:
a starter motor having a drive shaft, a pinion gear slidably mounted on the drive shaft, the pinion gear slidable from a non-engaged position to an engaged position along the drive shaft;
a solenoid on the assembly, the solenoid having a case, an armature, a coil on the case and disposed abut the armature, the case having an end cap and a armature cap;
a lever pivotably mounted on the assembly, the lever having a solenoid end on the armature, a gear end on the pinion gear and a pivot point on the assembly, the lever configured to position the pinion gear in the non-engageing position when the armature is in the rest position and pivoting about the pivot point when the armature is moved to a actuated position to slide the pinion gear into the engaged position; and
a mechanical actuator on the end cap, the mechanical actuator having a drive rod, and a handle, the drive rod having an axis, a armature end bearing against the armature and a handle end connected to the handle, wherein the handle is configured to move the drive rod axially between a start position and a non-start position, the start position having the drive rod engaged with the armature to bear against and mechanically move the armature to the actuated position.

2. The apparatus of claim 2 further comprising a spring on the mechanical actuator between the end cap and the handle, the spring bearing against the handle to hold the drive rod in the non-start position.

3. The apparatus of claim 2 further comprising a spring retainer between the spring and the handle.

4. The apparatus of claim 1 further comprising a rod tube on the end cap, the rod tube having a cap end attached to the cap, an inner surface and a handle end extending from the cap, the rod guide having a cylindrical aperture wherein the drive rod is slidably mounted in the rod tube.

5. The apparatus of claim 4 further comprising a spiral rod drive on the mechanical actuator, the spiral rod drive configured to translate rotational force from the handle to axial movement of the drive rod to engage and move the armature.

6. The apparatus of claim 5 wherein the spiral rod drive further comprises a first helical slot on the outer surface of drive rod and a first rod guide extending from the inner surface to engage the helical slot and translate the rotary movement of the handle to axial movement of the drive rod.

7. The apparatus of claim 5 where the spiral rod drive further comprises a second helical slot on the outer surface of the drive rod spaced from the first helical slot and a second rod guide extending from the inner surface and spaced from the first rod guide, the first and second rod guides configured to engage the first and second helical slots and translate the rotary movement of the handle to axial movement of the drive rod.

8. The apparatus of claim 7 wherein the handle is mounted to the drive rod between the first helical slot and the second helical slot whereby the position of the handle may be arranged to fit a particular starter assembly configuration.

9. The apparatus of claim 1 further comprising a depth adjuster on the distal end of the drive rod for adapting the drive rod to engage the armature.

10. An apparatus for use with an electric starter assembly having a starter motor and an electrical solenoid connected to the starter motor, the solenoid having a case, an armature, a coil connected between the case and the armature wherein the coil creates a magnetic field causing the armature to move axially from a rest position to an actuated position there by engaging starter motor to an engine temporarily for starting the invention comprising
a mechanical actuator having a base mounted on the case, the base having a cylindrical rod tube extending away from and axially aligned with the armature, the rod tube having an inner surface and a proximal end, a drive rod retainer formed in the inner surface;
a drive rod slidably mounted in the rod tube, the drive rod having an axis, an outer surface, a handle end and an armature end, a slot formed in the outer surface for slidably engaging the drive rod retainer; and
a handle on the handle end wherein the handle is used by a user to move the drive rod axially in the rod tube to engage the solenoid armature and move the armature into the actuated position thereby engaging the starter motor to the engine for starting.

11. The apparatus of claim 10 further comprising a spring and a spring retainer between the spring and the handle, the spring around the drive rod and bearing against the proximal end of the rod tube the spring retainer on the handle end between the spring and the handle, the spring bearing against the handle to prevent the drive rod from moving the armature out of the rest position.

12. The apparatus of claim 10 further comprising a spiral rod drive on the mechanical actuator, the spiral rod drive configured to translate rotational force from the handle to axial movement of the drive rod to engage and move the armature.

13. The apparatus of claim 12 wherein the spiral rod drive further comprises a plurality of helical slots in spaced relation formed on the outer surface of the drive rod and a plurality of rod guides on the rod tube extending into the rod guide, each of the plurality of helical slots configured to slidably engage one of the plurality of helical slots whereby rotating the drive rod with the handle causes the guides to ride in the slots and translate the rotary movement of the handle to axial movement of the drive rod.

14. The apparatus of claim 13 wherein the handle is mounted to the drive rod between two adjacent of the plurality of helical slots whereby the position of the handle may be arranged to fit a particular starter assembly configuration.

15. The apparatus of claim 10 further comprising a depth adjuster on the distal end of the drive rod for adapting the drive rod to engage the armature.

16. The apparatus of claim 15 wherein the depth adjuster is threadably connected to the armature end of the drive rod.

17. The apparatus of clam 11 wherein the handle is pivotally connected to the base wherein movement of the handle in a direction parallel to the axis of the drive rod moves the drive rod in the rod guide.

18. A method of actuating an electric starter assembly comprising:
providing a mechanical actuator base having a slidably mounted drive rod mounted on a solenoid having a solenoid armature wherein the drive rod is axially aligned with the armature for moving the armature from a rest position to an actuated position without electrically engaging the solenoid;
manipulating the drive rod to move into engagement with the armature to move the armature into a actuated position thereby engaging a starting motor to an engine;
energizing the starter motor to turn the engine to start the engine; and
manipulating the drive rod to allow the armature to move to the rest position.

19. The method of claim 18 further comprising:
providing a spring return on the mechanical actuator; and
providing an adjustable portion on the end of the drive rod adjacent to the armature.

20. The method of claim 19 further comprising:
providing a spiral drive arrangement on the drive rod and the actuator base comprising a plurality of helical slots formed in the drive rod and a plurality of guides in the base, each guide aligned with and configured to engage a helical slot on the drive rod wherein a rotation of the drive rod by force on a handle is translated into linear motion moving the drive rod to engage and move the armature.
